(19) United States
(12) Patent Application Publication
(10) Pub. No.: US 2019/0255800 A1
(43) Pub. Date: Aug. 22, 2019

(54) CUSHIONING SHEET

(71) Applicant: DEYORK LTD., New Taipei City (TW)

(72) Inventor: Hung Hsiang HSU, Taipei City (TW)

(73) Assignee: DEYORK LTD., New Taipei City (TW)

(21) Appl. No.: 16/388,629

(22) Filed: Apr. 18, 2019

(51) Int. Cl. B32B 3/12; A41D 13/015

(52) U.S. Cl. CPC B32B 3/12; A41D 13/015; A41D 2600/10; B32B 2571/00; B32B 2437/00; B32B 2307/558

(57) ABSTRACT

The present invention discloses a cushioning sheet used for being mounted on clothes and comprises: a cushioning member, a first layer body and a second layer body; the cushioning member comprises a plurality of cushioning blocks which are spaced to form a plurality of slots therein, and the cushioning blocks jointly construct a first attaching portion and a second attaching portion respectively on opposite sides; a partial area of the first layer body adjacent to the first attaching portion forms a first joining section, and the remaining area extends out of the first joining section to form a first outer periphery; a partial area of the second layer body adjacent to the second attaching portion forms a second joining section, and the remaining area extends out of the second joining section to form a second outer periphery; and wherein, the cushioning blocks have different height.

### FIELD OF THE INVENTION

The present disclosure relates to a cushioning sheet, and more particularly, to one which is mounted in sport protective gear.

### BACKGROUND

Shoulder pads, chest protectors, leg protectors or elbow pads are guards used to protect the user from injury during exercise or physical activity, such as impact, contusions, cuts, and bruises. In the design, in addition to the use of hard shells and other components to protect the human body, there is also a way to protect the human body by arranging a soft cushion on the protective gear to absorb energy.

Wherein, for this kind of production method of using the cushioning sheet to protect the human body, most of them is that first join the cushion body as a cushioning material with a layer body similar in size to the cushion body, and then simultaneously cut the layer body as well as the cushion body under the situation where they are joined together, which makes the cushion body and the layer body jointly form a cushioning sheet after the cushion body is formed with cushioning blocks of specific arrangement form on the layer body, and then mount the produced cushioning sheet onto the protective gear; however, such a production method is such that overall shape and contour of the finished cushion sheet is necessarily determined when cutting the cushion body bonded to the layer body during the manufacturing process; therefore, it is difficult to reserve a suitable mounting area on the layer body according to the actual use requirements to help the cushion body be securely attached to the protective gear later.

### SUMMARY

The main purpose of the present invention comprises providing a cushioning sheet; when a user mounts the cushioning sheet onto protective gear, on the cushioning sheet, a mounting area capable of being worked into suitable form by oneself is reserved.

The secondary purpose of the present invention comprises providing a cushioning sheet; the cushioning sheet has different cushioning capacities in different portions through change in thickness or material of cushioning material in local areas of the cushioning sheet.

To achieve above purpose, a cushioning sheet provided by the present invention is used to be mounted on clothes and comprises the following parts: a cushioning member comprising a plurality of cushioning blocks, and the cushioning blocks are spaced apart from each other to form a plurality of slots therein, and the cushioning blocks jointly construct a first attaching portion and a second attaching portion respectively on opposite sides; a first layer body, wherein a partial area of the first layer body adjacent to the first attaching portion forms a first joining section, and the remaining area extends out of the first joining section to form a first outer periphery; and a second layer body, wherein a partial area of the second layer body adjacent to the second attaching portion forms a second joining section, and the remaining area extends out of the second joining section to form a second outer periphery.

Wherein, the plurality of cushioning blocks have different height, such that the first attaching portion of the cushioning sheet is formed with a first height surface and a second height surface.

As for how to construct the first height surface and the second height surface, in different embodiment, the cushioning blocks of the cushioning member are constructed through stacking together a first elastic material and a second elastic material that is different from the first elastic material; or the cushioning blocks having the first height surface are composed of the first elastic material, while the cushioning blocks of the second height surface are composed of the second elastic material having different height from the first elastic material.

In another embodiment, the cushioning member has a central area as well as an edge area surrounding the central area, and the edges of the plurality of the cushioning blocks in the edge area separately form an arc surface.

As can be seen from above explanation, the present invention has a feature that a mounting area capable of being worked into suitable form by a user oneself is reserved on the cushioning sheet, so as to subsequently mount the cushioning sheet onto protective gear. Furthermore, the cushioning sheet has different cushioning capacities in different portions through change in thickness of cushioning material in local portions of the cushioning sheet.

### BRIEF DESCRIPTION OF THE DRAWINGS

FIG. 1A is a schematic three dimensional view of the cushioning sheet of the present invention according to a embodiment;

FIG. 1B is a schematic section view of mounting the cushioning sheet of FIG. 1A onto clothes;

FIG. 1C is a schematic section view of mounting the cushioning sheet of the present invention onto clothes according to another embodiment;

FIG. 2 is a schematic three dimensional view of the cushioning sheet of the present invention according to yet another embodiment;

FIG. 3A is a schematic illustrating the central area of the cushioning sheet in FIG. 2;

FIG. 3B is a schematic section view taken along section A-A in FIG. 3A;

FIG. 4 is a schematic illustrating process of the manufacturing method for the cushioning sheet of the present invention according to an embodiment;

FIG. 5A is a schematic three dimensional view of the die-cut mold according to an embodiment;

FIG. 5B is a schematic section view of the die-cut mold;

FIGS. 5C to 5D are schematic section view of the cutting step in FIG. 4;

FIG. 5E is a schematic illustrating the first bonding step in FIG. 4;

FIG. 5F is a schematic illustrating the second bonding step in FIG. 4;

FIG. 5G is a schematic illustrating the cushioning sheet;

FIG. 6 is a schematic illustrating the manufacturing method for the cushioning sheet of the present invention according to another embodiment;

FIG. 7 is a schematic illustrating the process of the manufacturing method for the cushioning sheet in FIG. 1A; and

FIGS. 8A to 8E are schematic illustrating the combining step in FIG. 7.

### DETAILED DESCRIPTION OF PREFERRED EMBODIMENTS

In order to further understand the structure, usage and features of the present invention more clearly and in detail, the present invention is described in detail below with references to the accompanying drawings and specific preferred embodiments:

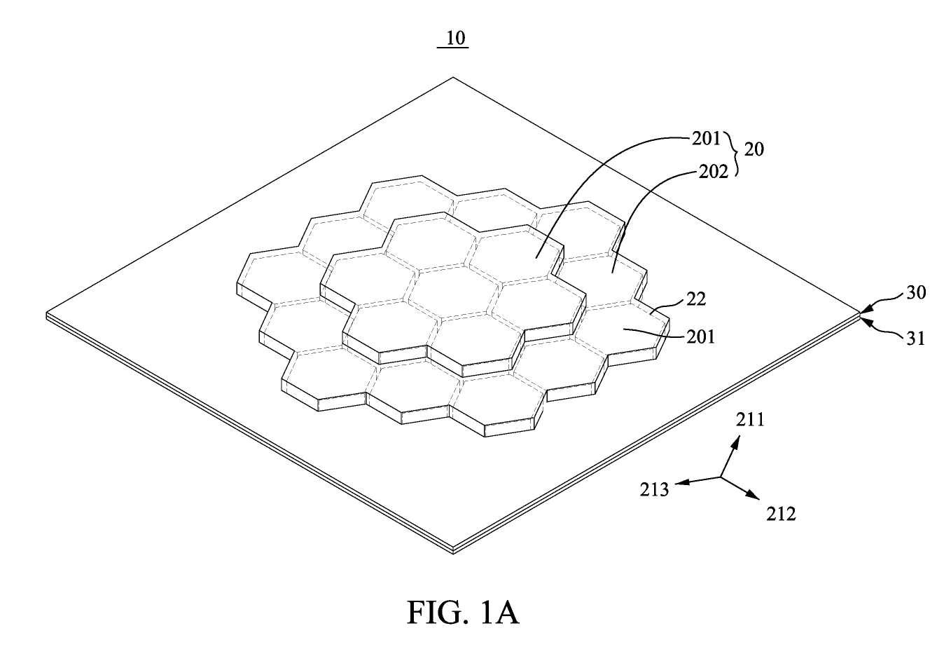

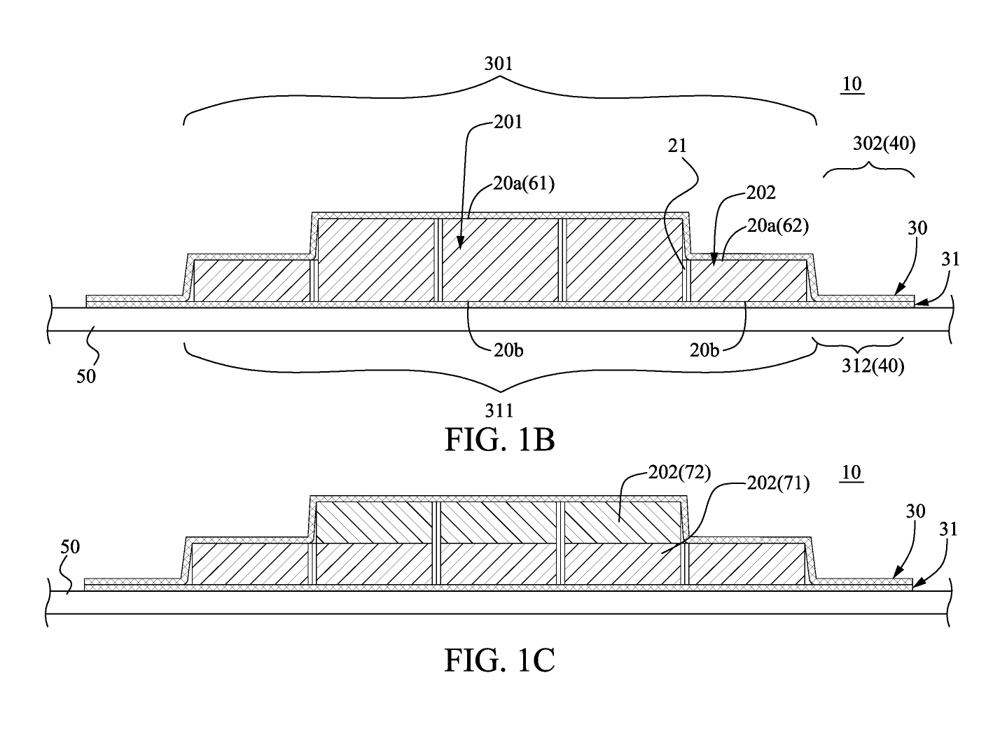

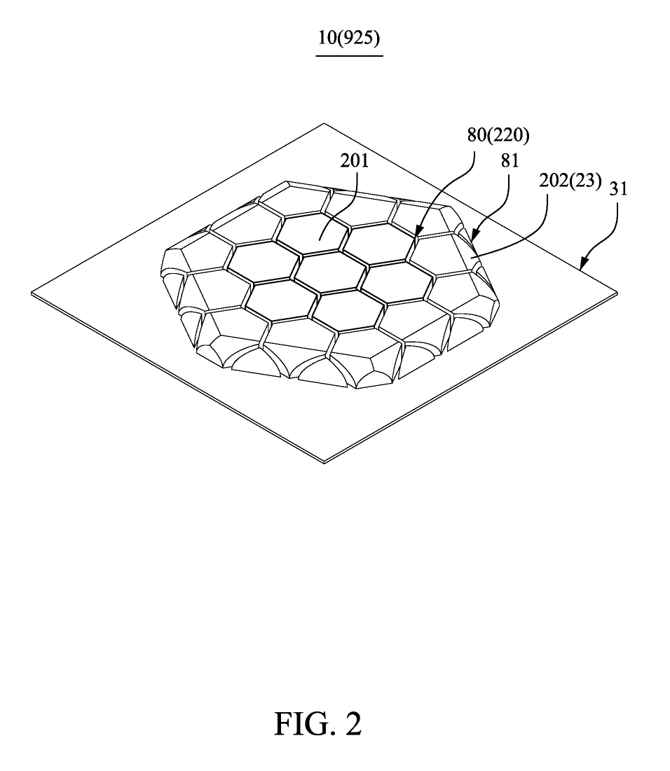

First, as for the structure of the cushioning sheet 10 provided by the present invention, please refer to FIGS. 1A to 3B. First, please refer to FIGS. 1A to 3C. The cushioning sheet 10 provided by the present invention is used to be mounted onto clothes, and has structure comprising: a cushion member 20, a first layer body 30 and a second layer body 31.

The cushioning member 20 comprises a plurality of cushioning blocks 201 and a plurality of second cushioning blocks 202, and the cushioning blocks 201 and the second cushioning blocks 202 are arranged as spaced apart from each other (and completely separated from each other), and thus a plurality of slots 21 is formed therein. The cushioning blocks 201 and the second cushioning blocks 202 jointly construct a first attaching portion 20a and a second attaching portion 20b on opposite sides.

Wherein, as for shape aspect in the present embodiment, the slots 21 are respectively arranged along a first direction 211, a second direction 212 and a third direction 213, such that the cushioning blocks 201 show a form of hexagon 22; however, in other embodiments, the cushioning blocks 201 may be geometric patterns of other arbitrary shapes; in material aspect, the materials of the cushioning block 201 are not limited in the present invention, and the cushioning block 201 may be fabricated by using existing common cushion materials.

A partial area of the first layer body 30 adjacent to the first attaching portion 20a of the cushioning block 201 forms a first joining section 301, while the remaining area extends out of the first joining section 301 to form a first outer periphery 302; a partial area of the second layer body 31 adjacent to the second attaching portion 20b forms a second joining section 311, while the remaining area extends out of the second joining section 311 to form a second outer periphery 312; the first outer periphery 302 and the second outer periphery 312 jointly form a mounting area 40 when used to be attached to the clothes 50, which is for a user to change the shape of the mounting area 40 by cutting or the like according to requirements when using; wherein, in the present embodiment, the layer bodies 30, 31 are only respectively attached to the first attaching portion 20a and the second attaching portion 20b, but not directly attached to the side of the cushioning blocks 201, 202, while also may be attached to the side of the cushioning blocks 201, 202 in other embodiments.

Furthermore, in a different embodiment, the partial first outer periphery 302 and the partial second outer periphery 312 in the cushioning sheet 10 may have been attached to each other when the cushioning sheet 10 is on sale; or in another embodiment, when the cushioning sheet 10 is on sale, the first outer periphery 302 and the second outer periphery 312 may temporarily not be attached to each other, and may not be attached to each other until to be attached to the clothes 50, which is for changing respective contours of the outer periphery 302, 312 or tension of the layer bodies 30, 31 according to the usage or the size requirement of the clothes 50, thus to make personalized adjustments based on the needs of the user wearing the clothes 50.

There is no limitation on the connection method of a portion where the first layer body 30 and the second layer body 31 are in direct contact with each other; the first layer body 30 and the second layer body 31 may be joined together beforehand by heat press or adhesive, and then the cushioning sheet 10 is attached to the clothes 50; or one of layer bodies, for example, the first layer body 30, first is attached to the clothes 50, and then the other layer body is attached to the first layer body 30; through this, tension degrees of the different layer bodies can be separately adjusted to affect the property of the cushioning sheet 10; in different embodiments, the first layer body 30 and the second layer body 31 can be composed of the same or different elastic materials.

Please refer to FIGS. 1A and 1B. In order to strengthen the protection for a specific part, in the present embodiment, the cushioning member 20 includes two different height cushioning blocks (the cushioning block 201 and the second cushioning block 202), so that the first attaching portion 20a constructed by the plurality of cushioning blocks 201, 202 is formed with different heights of a first height surface 61 and a second height surface 62.

Wherein, about how to form the first height surface 61 and the second height surface 62, in the embodiment in FIG. 1B, the first height surface 61 and the second height surface 62 are formed by different heights of the cushioning blocks 201 and the second cushioning blocks 202; however, in another embodiment, as shown in FIG. 1C, the first height surface 61 and the second height surface 62 can be formed through stacking the second cushioning block 202 composed of a first elastic material 71 and the second cushioning block 202 composed of a second elastic material 72 together.

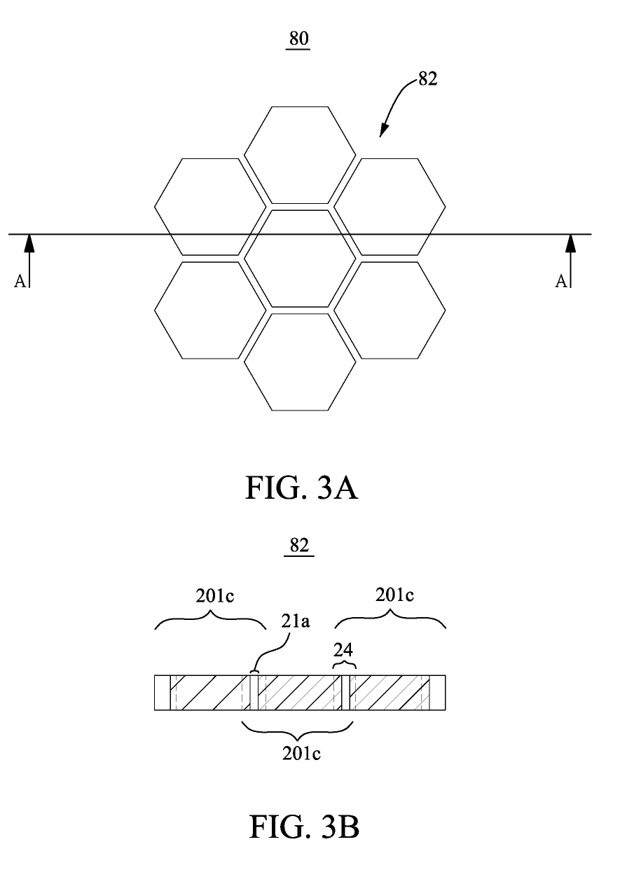

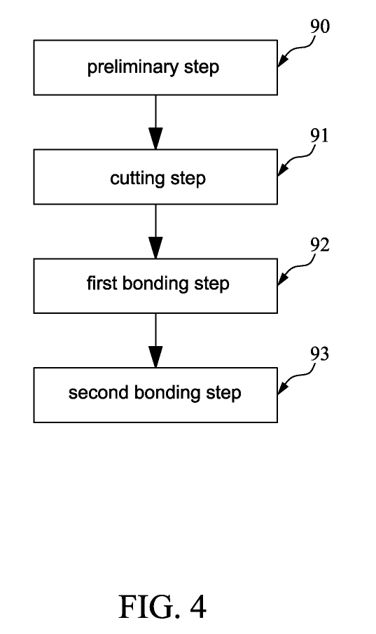

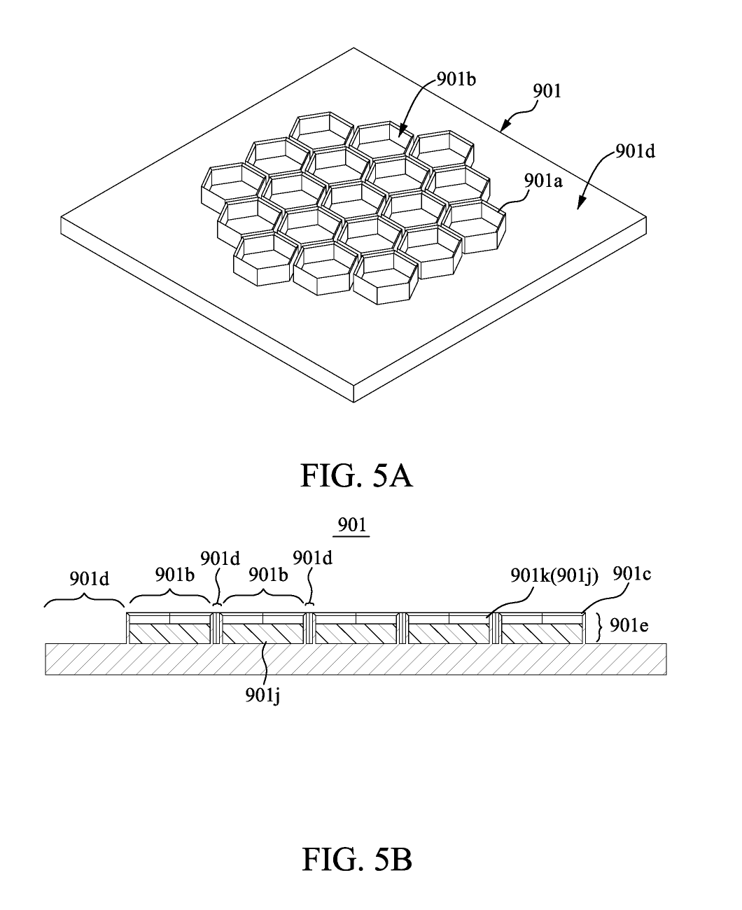

As shown in FIG. 2 (for convenience of explanation, the second layer body 31 is not drawn in FIG. 2, and the cushioning block 201 and the second cushioning block 202 have the same height), in order to enhance the protection ability of the cushioning sheet 10 at a specific portion (the central portion of the cushioning sheet 10 in the figure), the cushioning member 20 has a central area 80 (the shape and the size can be changed as requirements) as a special area and composed of the cushioning blocks 201 of the same shape, as well as an edge area 81 surrounding the central area 80. The cushioning blocks 201 in the central area 80 have a set shape 220 (the hexagon 22 in the present embodiment) to show the regularity and be tightly arranged to form a regular region 82. The second cushioning blocks 202 in the edge area 81 can separately have various shapes, and even an arc surface 23 may be formed on the respective edges of the second cushioning blocks 202 in the edge area 81.

Wherein, as for explanation on the regular region 82, please refer to FIGS. 1, 3A and 3B. Because the cushioning block 201 shows the shape of the hexagon 22 and a width 21a of the slot 21 among them is smaller than a width 201c of the cushioning block 201, an overlapping section 24 among the cushioning blocks 201 is generated, from a cross-sectional view. Through it, when the cushioning sheet deforms, due to an arrangement manner of the hexagon of the cushioning blocks 201, the slots 21 would be obliquely arranged in different directions between therein.

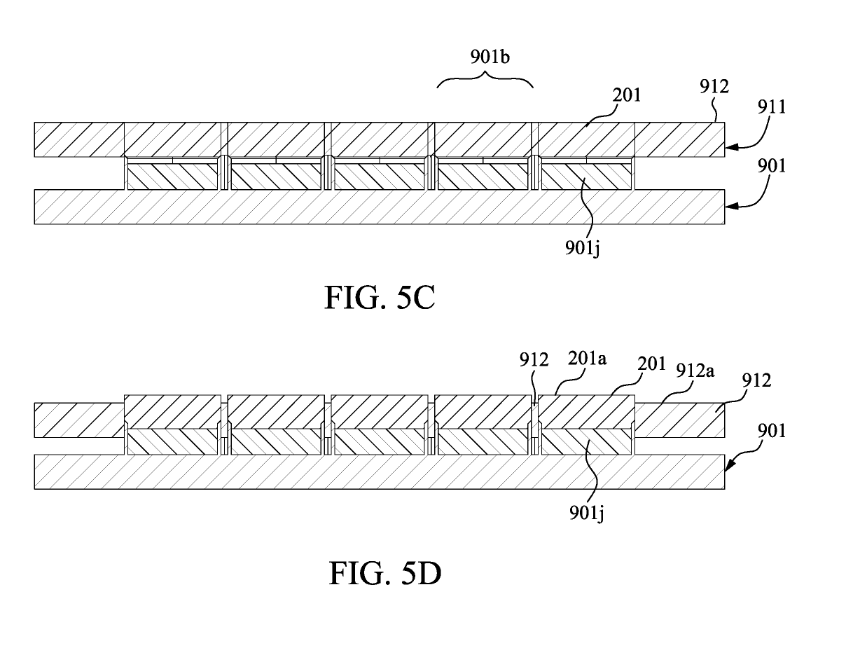

As for a manufacturing method about how to make the cushioning sheet 10, please refer to FIGS. 4 to 8D. The following will explain the method step by step: as shown in FIG. 4, the manufacturing method for the cushioning sheet 10 provided by the present invention comprises: a preliminary step 90, a cutting step 91, a first bonding step 92 and a second bonding step 93.

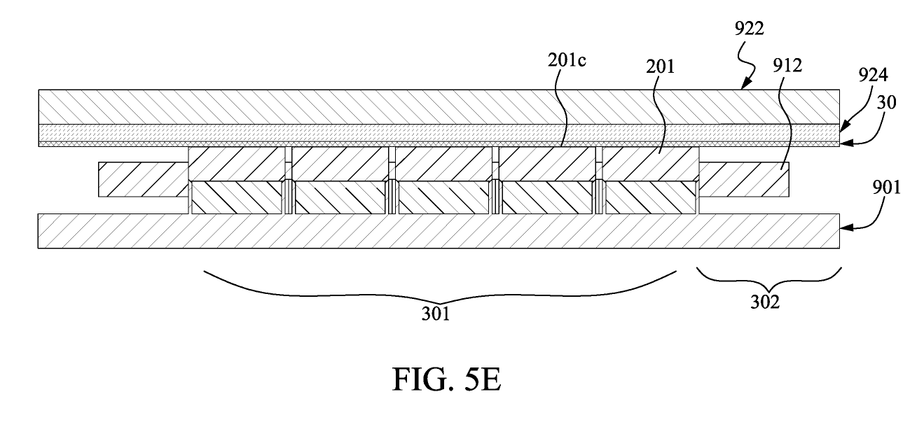

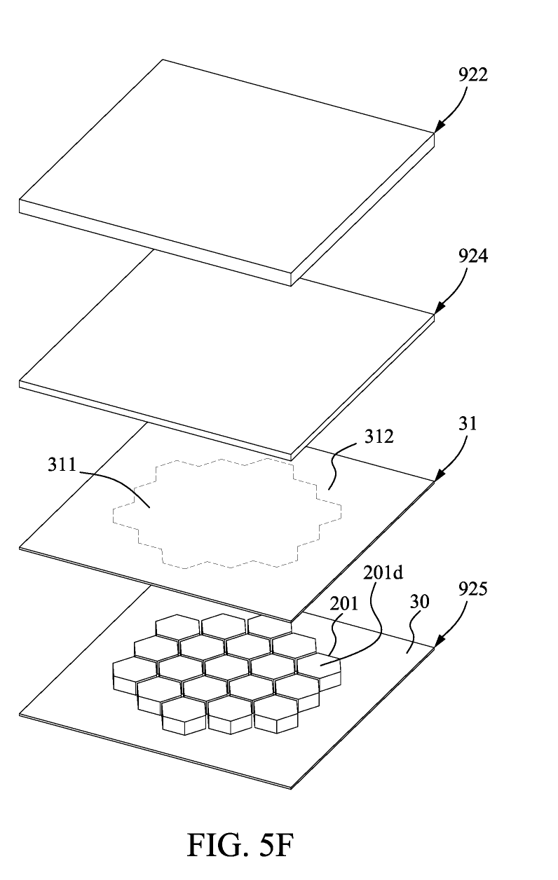

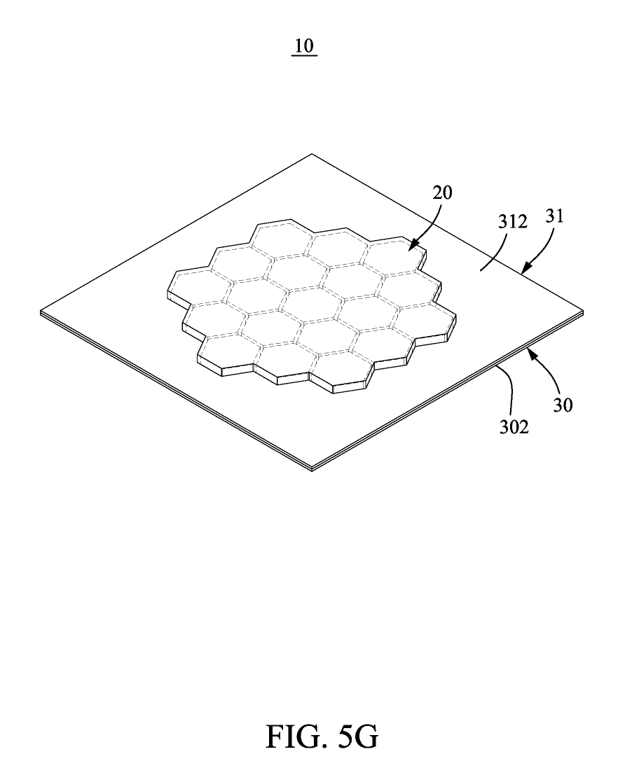

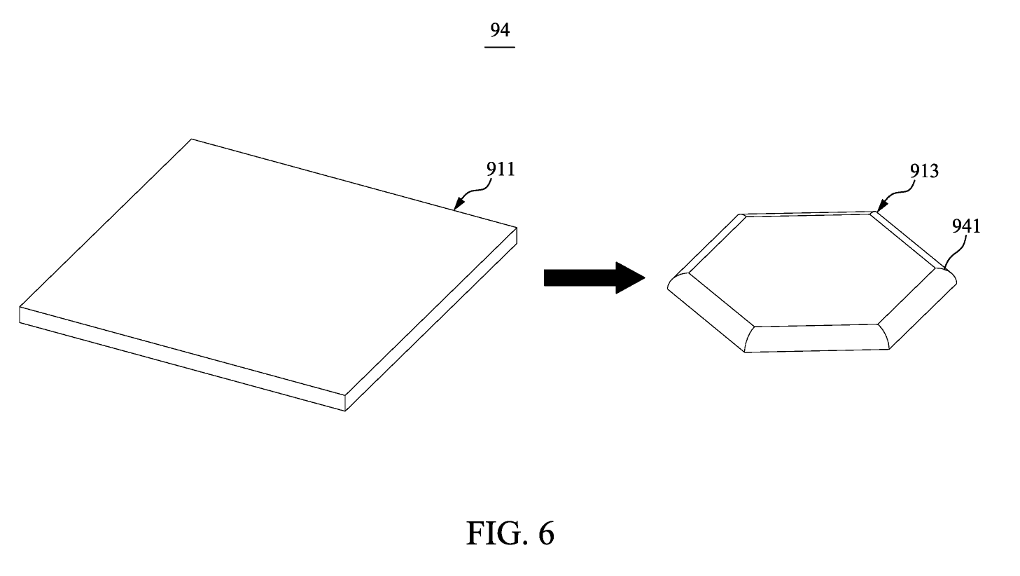

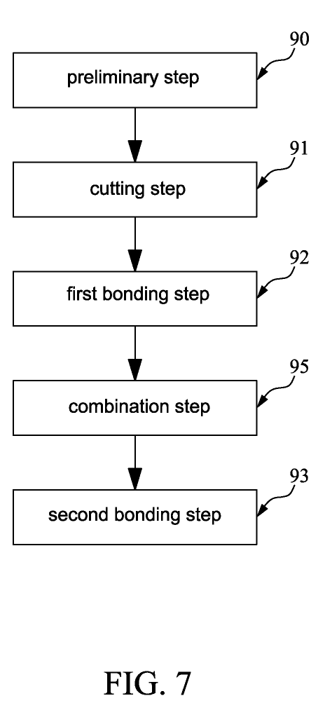

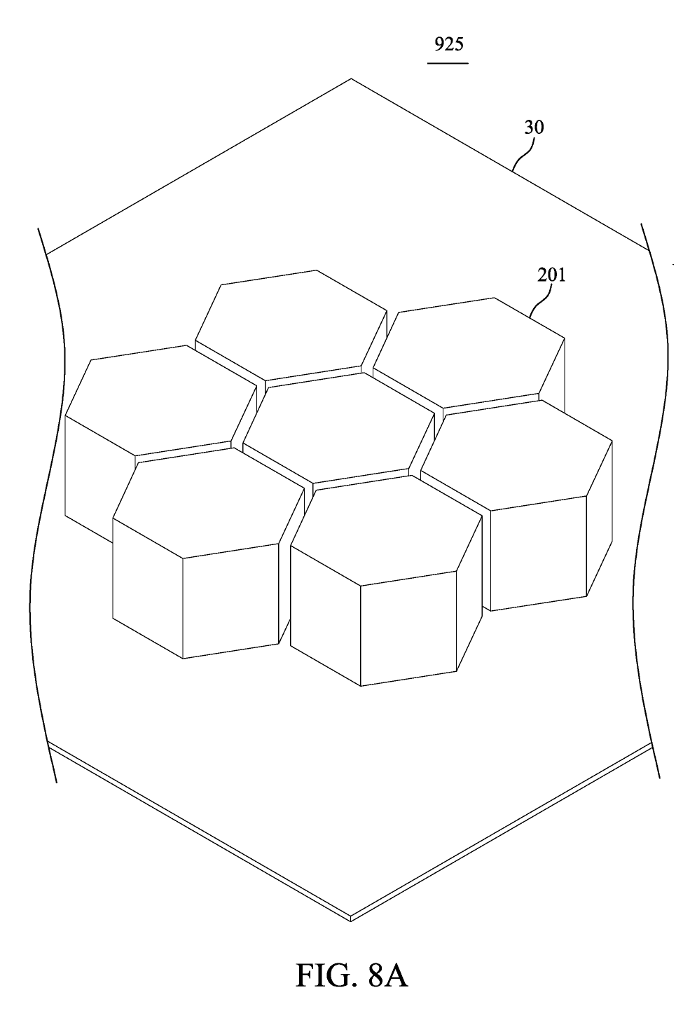

Please refer to FIGS. 5A to 5B. In the preliminary step 90: a die-cut mold 901 is provided, and the die-cut mold 901 has a plurality of cutters 901a, wherein the cutters 901a have the same height and jointly encircle a first area 901b for determining the form and arrangement manner of the cushioning blocks 201 (like hexagon 22 in the figure), as well as determining a second area 901d outside the first area 901b; furthermore, the first area 901b is further arranged with a filler 901j such that a depth 901c of the first area 901b is different from a depth 901e of the second area 901d; for the convenience of arrangement, the filler 901j may be made of elastic materials.

Then, please refer to FIGS. 5C to 5D. In the cutting step 91: Stamping a substrate 911 with the die-cut mold 901 makes the substrate 911 generate a plurality of cushioning blocks 201 positioned in the first area 901b and remnants 912 positioned in the second area 901d, and a horizontal location 201a positioned on the die-cut mold 901 is higher than a horizontal location 912a of the remnants 912.

Wherein, because the depths 901d, 901f of the first area 901b and the second area 901b are different, as well as the substrate 911 can be compressed and locally deformed during cutting, so that after cut, the plurality of separately independent cushioning blocks 201 positioned on the die-cut mold 901 are formed on the first area 901b, and other portion of the substrate 911, i.e., the portion in the second area 901d, forms the remnants 912.

Please refer to FIG. 5E. In the first bonding step 92, the first layer body 30 is heated by a heater 922 and applied with pressure, so that the partial cushioning block 201 near a side of the heater 922 is partially melted and adheres to the first layer body 30, and accordingly the first joining section 301 of the layer body 30 is joined to a first attaching portion 20a of the cushioning block 201, as well as the first layer body 30 and the die-cut mold 901 are respectively attached to opposite sides of the cushioning block 201, and then the cushioning blocks 201 is separated from the die-cut mold 901 as well as the remnants 912 on the die-cut mold 901 to produce a semi-finished product 925 as shown in FIG. 5F; wherein, the first layer body 30 has an area larger than an area of the cushioning member 20, so that the first layer body 30 has the first outer periphery 302 located at the surrounding of the first joining section 301.

Please refer to FIGS. 5F to 5G. In the second bonding step 93, similarly a second joining section 311 of the second layer body 31 which has a larger area than the cushioning member 20 is joined to a second attaching portion 20 (the second layer body 31 also has a second outer periphery 312 located at the surrounding of the second joining section 311) of the cushioning block 201, such that the first layer body 30 and the second layer body 31 respectively are attached to opposite sides of the cushioning block 201 to make the cushioning sheet 10; wherein, for the convenience of presentation, the cushioning block 201 in FIG. 5F is not drawn as scale, and the joining manner may refer to the description of the joining between the first layer body 30 and the cushioning block 201.

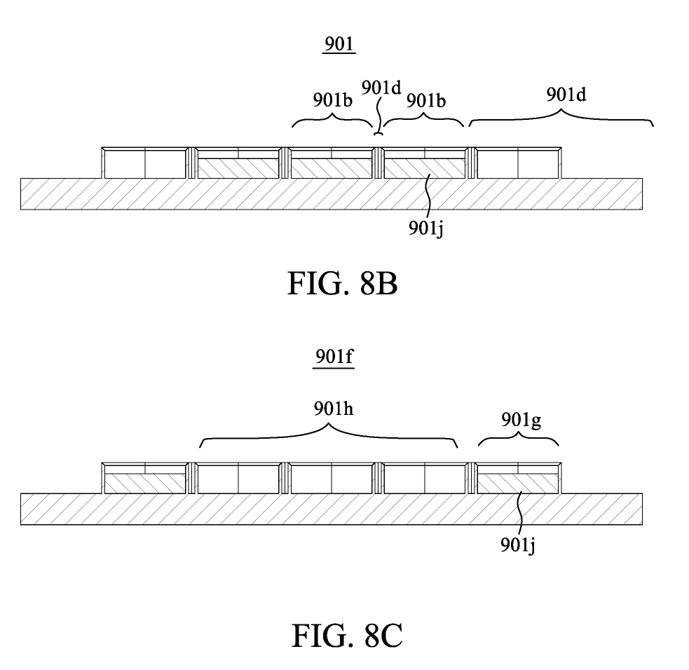

Please refer to FIGS. 2 and 6. To produce the cushioning sheet 10 having slight change in form of local position as shown in FIG. 2, the manufacturing method of the cushioning sheet 10 can further comprises a preceding step 94; in the preceding step 94, working the substrate 911 (e.g., hot-press cutting) produces a preparation material 913 having a round corner 941 at the edge and having a size generally corresponding to the size of the cushioning member 20 which is to be finally produced, and the preparation material 913 is used as the substrate 911 cut in the subsequent cutting step 901, which makes the produced cushioning member 20 affected by the preceding step 94 to generate a cushioning member 20 having the arc surface 23 as shown in FIG. 2

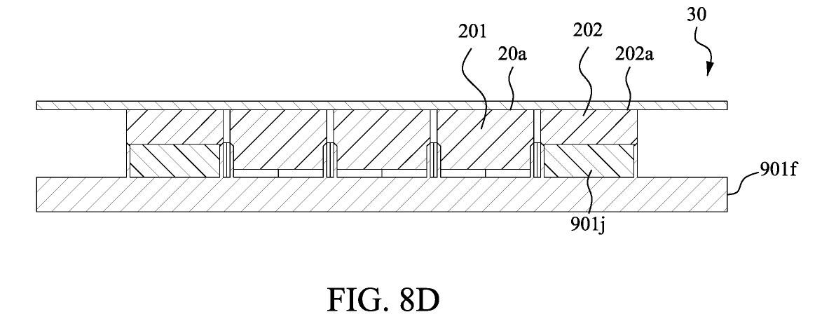

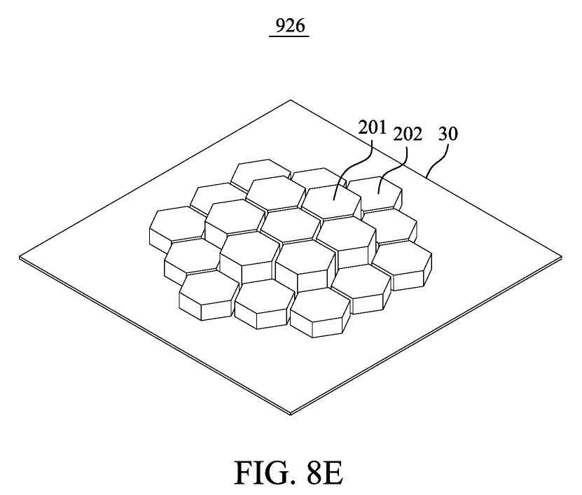

Please refer to FIGS. 7 to 8D. To produce the cushioning sheet 10 having two kinds of the materials (61, 62) in FIGS. 1A to 1C, the local thickness of the cushioning sheet 10 can be changed by adding a combination step 95 between the first bonding step 92 and the second bonding step 93.

First please refer to FIGS. 7, 8A and 8B. After using the die-cut mold 901 of FIG. 8B in the cutting step 91 and after subsequent steps to produce the semi-finished product 925 as shown in FIG. 8A having the cushioning block 201 made of the elastic material 71, in the combining step 95, first a second die-cut mold 901f as shown in FIG. 8C is prepared; wherein, the second die-cut mold 901f is provided with a third area 901g, which is used for making at least one second cushioning block 202 disposed in the third area 901g and composed of the second elastic material 72 after stamping a second substrate (not shown in the figure) by the second die-cut mold 901f; besides the third area 901g, the second die-cut mold 901f may also be arranged with a fourth area 901h capable of being corresponding to the first area 901b of the die-cut mold 901.

As shown in FIG. 8D, after using the second die-cut mold 901f to produce the second cushioning block 202, the cushioning blocks 201 of the semi-finished product 925 are arranged in the fourth area 901h, which makes the cushioning blocks 201 and the second cushioning blocks 202 positioned relative to each other and makes the first layer body 30 of the semi-finished product 925 and the second cushioning block 202 able to be positioned relative to each other; this is so as to produce a second semi-finished product 926 having the cushioning blocks 201 and the second cushioning blocks 202 as shown in FIG. 8E after joining the second cushioning blocks 202 and the first layer body 30 together, and this is so as to perform the subsequent second bonding step 93.

What is claimed is:

1. A cushioning sheet, used for being mounted on clothes, comprising:
a cushioning member comprising a plurality of cushioning blocks, the cushioning blocks being spaced apart from each other to form a plurality of slots therein, wherein the cushioning blocks jointly construct a first attaching portion and a second attaching portion respectively on opposite sides;
a first layer body, wherein a partial area of the first layer body adjacent to the first attaching portion forms a first joining section, and the remaining area extends out of the first joining section to form a first outer periphery;
a second layer body, wherein a partial area of the second layer body adjacent to the second attaching portion forms a second joining section, and the remaining area extends out of the second joining section to form a second outer periphery; and
Wherein the plurality of cushioning blocks have different height, such that the first attaching portion of the cushioning sheet is formed with a first height surface and a second height surface.

2. The cushioning sheet according to claim 1, wherein the cushioning blocks of the cushioning member are constructed through stacking together a first elastic material and a second elastic material that is different from the first elastic material.

3. The cushioning sheet according to claim 1, wherein the cushioning blocks having the first height surface are composed of the first elastic material, while the cushioning blocks of the second height surface are composed of the second elastic material having different height from the first elastic material.

4. The impact-resistant pad according to claim 1, wherein the cushioning member has a central area as well as an edge area surrounding the central area, and the edges of the plurality of the cushioning blocks in the edge area separately form an arc surface.
